(19) United States
(12) Patent Application Publication
(10) Pub. No.: US 2016/0279696 A1
(43) Pub. Date: Sep. 29, 2016

(54) BICYCLE CHAIN BREAKER ASSEMBLY

(71) Applicant: Tuo-Jen Chen, Taichung City (TW)

(72) Inventor: Tuo-Jen Chen, Taichung City (TW)

(21) Appl. No.: 14/664,923

(22) Filed: Mar. 23, 2015

(51) Int. Cl. B21L 21/00; B25F 1/04

(52) U.S. Cl. CPC B21L 21/00; B25F 1/04

(57) ABSTRACT

A bicycle breaker assembly received in a folding tool unit includes a chain breaker having a body which has a first protrusion and a second protrusion respectively extending from two ends thereof, and a recess is defined in between the first and second protrusion. A push member threadedly extends through the first protrusion. A tire-removal member is pivotably connected to the second protrusion. The second protrusion has a groove, and a support member extends from the recess. The tire-removal member has a stop extending therefrom which contacts the body when the tire-removal member is pivoted relative to the second protrusion of the body.

### BACKGROUND OF THE INVENTION

1. Fields of the Invention

The present invention relates to a bicycle chain breaker assembly.

2. Descriptions of Related Art

The conventional bicycle tool assemblies generally comprise a body with two protrusions on two ends thereof. Multiple tools are pivotably connected to one of the protrusions by a pin or rivet. When using the tools, each of the tools is pivoted away from the body so that the user holds the body to rotate the tool. However, the tools are easily loosened and cannot be positioned at their folded positions after a period of time of use.

One of the conventional bicycle chain breaker assemblies comprises a body and an arm is pivotably connected to the body so that the user can hold the arm to operate the chain breaker to repair the chain. Nevertheless, the arm cannot be well positioned relative to the body and may be loosened relative to the body.

Another chain breaker assembly uses a tire-removal member to perform as a handle so as to easily operate the chain breaker assembly. When in use, the tire-removal member is detached from the tool assembly and then the protrusion of the tire-removal member is engaged with the recess of the body of the chain breaker assembly to connect the tire-removal member to the body. The cooperation between the body and the tire-removal member requires specific structure, and which means that the structure of the tool assembly is complicated.

The present invention intends to provide a bicycle breaker assembly to improve the shortcomings mentioned above.

### SUMMARY OF THE INVENTION

The present invention relates to a bicycle breaker assembly received in a folding tool unit, and the bicycle breaker assembly comprises a chain breaker having a body and a push member. The body has a recess defined in the first side of the middle portion of the body. A first protrusion and a second protrusion respectively extend from the first side of two ends of the body. The first protrusion has a threaded hole, and the second protrusion has a groove which communicates with the recess. A locking hole is defined in one side of the second protrusion. The push member has a first end pivotably connected to the folding tool unit, and a second end of the push member threadedly extend through the threaded hole and reaches into the recess. A tire-removal member has a first end pivotably connected to the second protrusion. A through hole is defined through the first end of the tire-removal member. A sleeve extends through the through hole. A bolt extends through a passage defined axially through the sleeve and is threadedly connected to the locking hole to pivotably connect the first end of the tire-removal member to the body. A stop extending from one side of the tire-removal member at an angle and is removably in contact with the second side of the body to restrict the rotational angle of the tire-removal member relative to the body.

Preferably, the second protrusion has a sink hole co-axially defined in one end of the locking hole and communicating with the locking hole. A ring washer is located in the sink hole and has a hole defined therethrough. The sleeve extends through the hole of the ring washer such that the lower end of the sleeve is in flush with the underside of the ring washer.

Preferably, a wave washer is located in the sink hole, and the ring washer is overlapped on the wave washer. The wave washer has multiple peaks and multiple valleys which are located alternatively to the peaks. The peaks contact the inner face of the sink hole and the ring washer so as to increase a gap between the body and the tire-removal member.

Preferably, the body has a first end face formed on the outer side of the second protrusion, and a second end face is formed on the outer side of the first protrusion. A resting face is connected between the first and second end faces. The stop of the tire-removal member contacts the first end face when the tire-removal member is pivoted at an angle relative to the body. Te second end of the push member reaches into the recess,.

Preferably, a support member extends from the inner face of the recess and has a curved recess. The support member is located at a distance from the first and second protrusions.

Preferably, the tire-removal member has an operation end formed at the second end thereof The operation end is tapered toward the distal end thereof.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the chain breaker assembly of the present invention;

FIG. 2 is a cross sectional view of the chain breaker assembly of the present invention;

FIG. 3 shows that the chain breaker assembly of the present invention is assembled to the folding tool unit;

FIGS. 4 and 5 show that the tire-removal member is pivoted at an angle relative to the body of the chain breaker assembly of the present invention;

FIG. 6 shows that the chain breaker assembly of the present invention is used to repair a chain, and

FIG. 7 is an enlarged view of a portion in FIG. 6.

### DETAILED DESCRIPTION OF THE PREFERRED EMBODIMENT

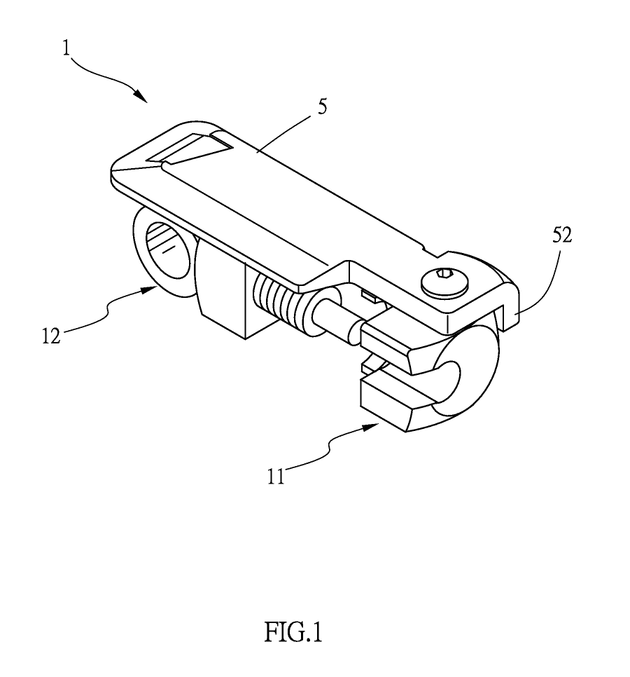

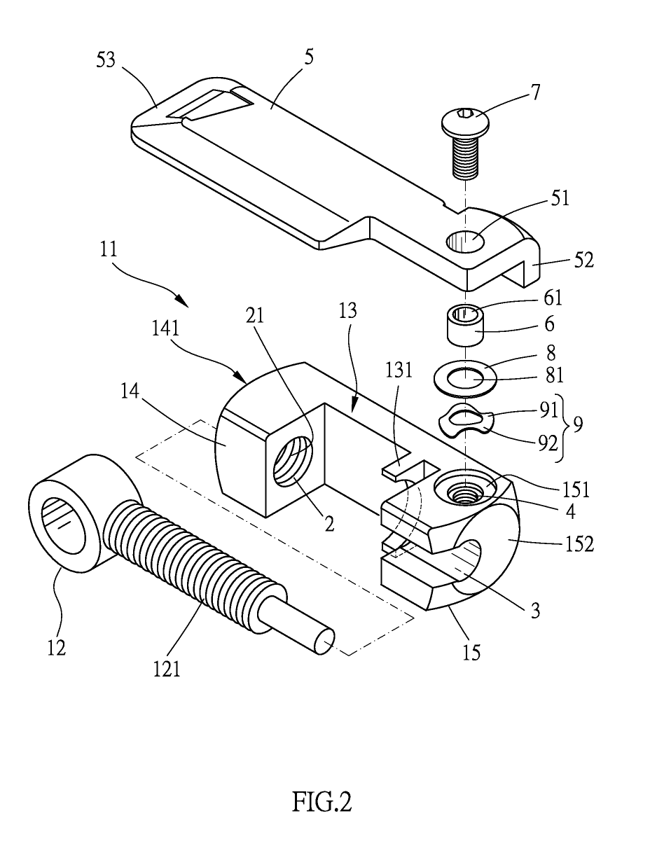

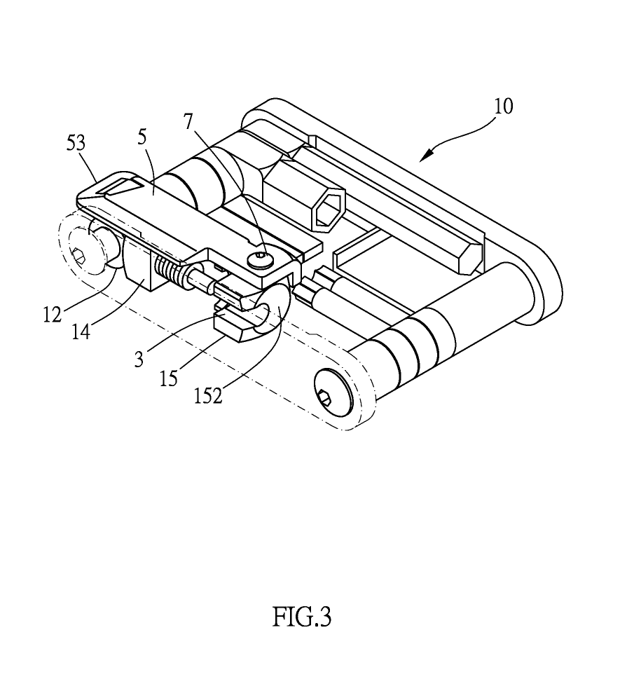

Referring to FIGS. 1 to 7, the chain breaker assembly of the present invention is assembled to a folding tool unit 10 and used to repair a bicycle chain 20 as shown in FIG. 3. The chain breaker assembly comprises a chain breaker 1 having a body 11 and a push member 12. The body 11 has a recess 13 defined in the first side of the middle portion of the body. A first protrusion 14 and a second protrusion 15 respectively extend from the first side of two ends of the body 11. The first protrusion 14 has a threaded hole 2 defined therethrough which has inner threads 21. The second protrusion 15 has a groove 3 defined in the distal end thereof The groove 3 communicates with the recess 13. A locking hole 4 is defined in one side of the second protrusion 15. The body 11 has a first end face 151 formed on the outer side of the second protrusion 15, and a second end face 141 is formed on the outer side of the first protrusion 14. A resting face 111 is connected between the first and second end faces 152, 141. A support member 131 extends from the inner face of the recess 13, and has a curved recess. The support member 131 is located at a distance from the first and second protrusions 14, 15. The distance between the support member 131 and the first protrusion 14 is larger than that between the support member 131 and the second protrusion 15.

The second protrusion 15 further has a sink hole 151 co-axially defined in one end of the locking hole 4 and communicates with the locking hole 4. A ring washer 8 is located in the sink hole 151 and has a hole 81 defined therethrough. The sleeve 6 extends through the hole 81 of the ring washer 8, and the lower end of the sleeve 6 is in flush with the underside of the ring washer 8. Furthermore, a wave washer 9 is located in the sink hole 151, and the ring washer 8 is overlapped on the wave washer 9. The wave washer 9 has multiple peaks 91 and multiple valleys 92 which are located alternatively to the peaks 91. The push member 12 has the first end which is a ring, pivotably connected to the folding tool unit 10, and the shank of the push member 12 has outer threads 121 which are threadedly engaged with the inner threads 21 of the threaded hole 2 of the first protrusion 14. The second end of the push member 12 reaches into the recess 13.

A tire-removal member 5 has a first end pivotably connected to the second protrusion 15, and a through hole 51 is defined through the first end of the tire-removal member 5. A sleeve 6 with a passage 61 defined axially therethrough extends through the through hole 51. A bolt 7 extending through a passage 61 defined axially through the sleeve 6, the ring washer 8 and the wave washer 9, and is threadedly connected to the locking hole 4 to pivotably connect the first end of the tire-removal member 5 to the body 11. The tire-removal member 5 is rested on the resting face 111 when not in use as shown in FIG. 1. It is noted that the peaks 91 contact the inner face of the sink hole 151 and the ring washer 8 to increase a gap between the body 11 and the tire-removal member 5. That is to say, the tire-removal member 5 can be pivoted about the bolt 7, and the ring washer 8 and the wave washer 9 provide a better connection between the tire-removal member 5 and the body 11 so that the tire-removal member 5 is not loosened. The tire-removal member 5 has an operation end 53 formed at the second end thereof, the operation end 53 is tapered toward a distal end thereof. The operation end 53 is tapered toward the distal end thereof so as to easily remove the tire from the rim. A stop 52 extends from one side of the tire-removal member 5 at an angle and is removably in contact with a second side of the body 11 as shown in FIG. 1, to restrict the rotational angle of the tire-removal member 5 relative to the body 11.

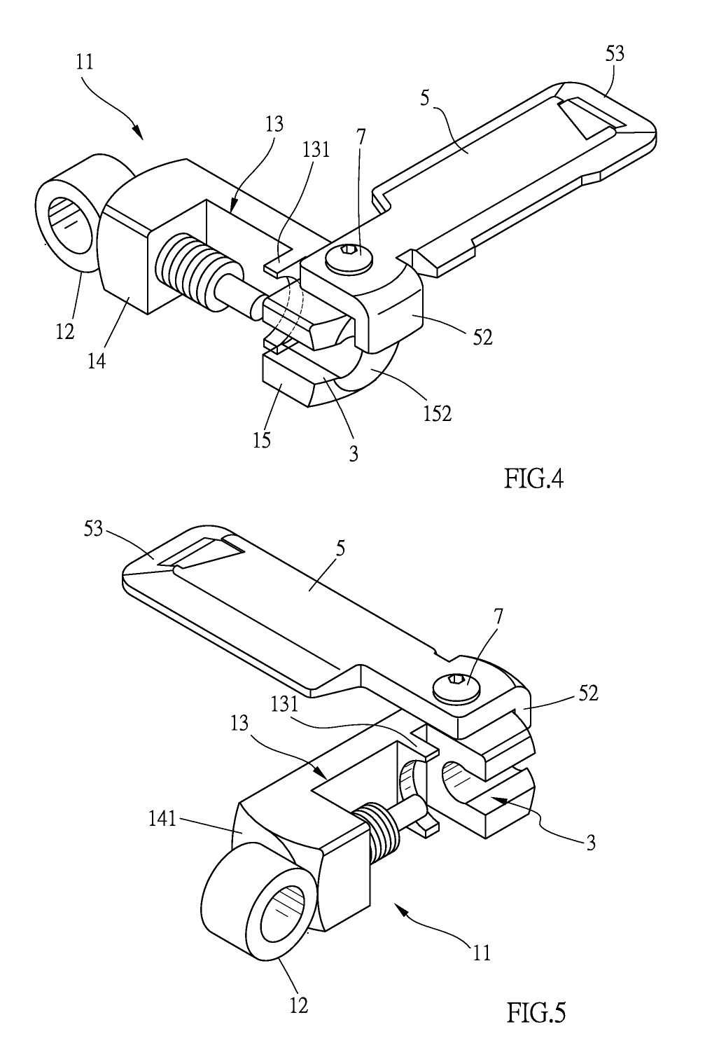

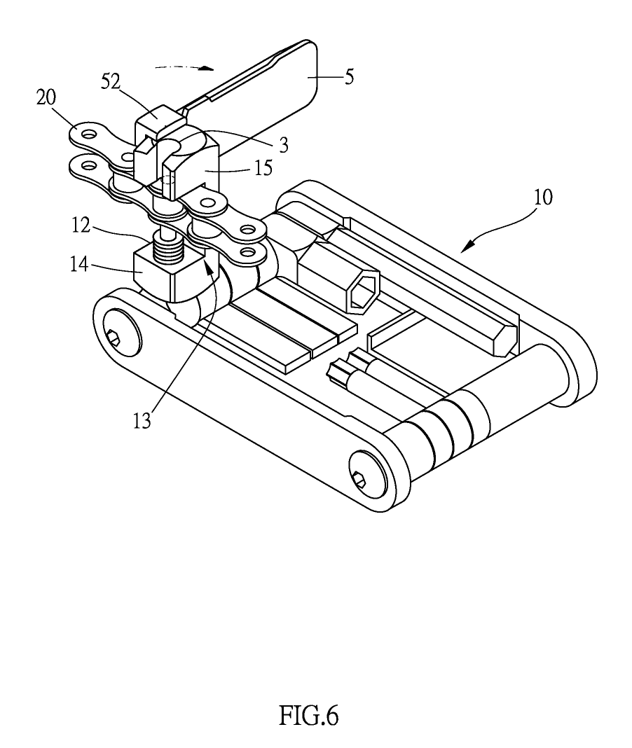

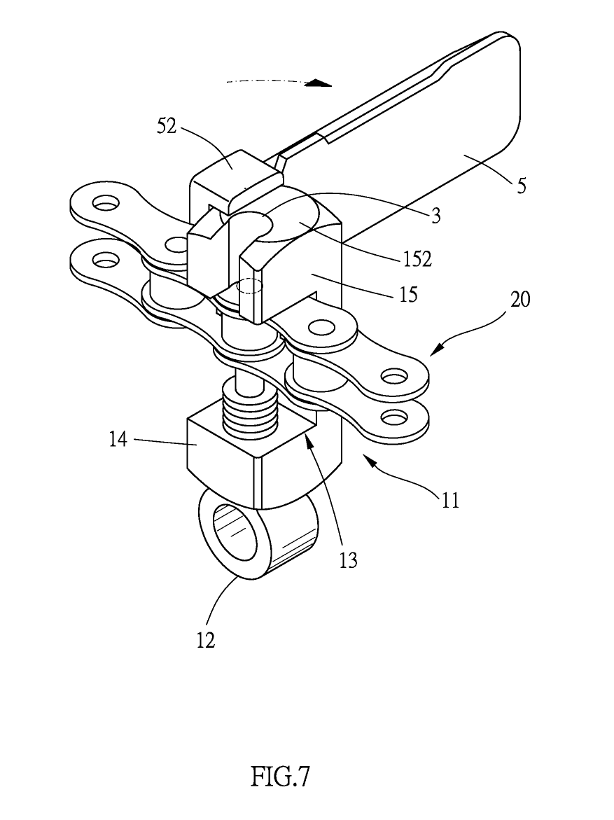

As shown in FIGS. 4 and 5, when in use, the tire-removal member 5 is pivoted about the bolt 7 to a position perpendicular to the body 11, the stop 52 of the tire-removal member 5 contacts the first end face 152. The user can hold the tire-removal member 5 and rotate the folding tool unit 10 to rotate the push rod 12 relative to the body 11. When breaking the chain 20, as shown in FIGS. 6 and 7, the push rod 12 is moved back and the chain 20 is positioned in the recess 13. The chain 20 is positioned between the support member 131 and the first protrusion 14, the pin to be replaced is located in alignment with the push rod 12. The push rod 12 is then moved forward to push the pin out from the plates of the chain 20. The sleeve 6 allows the tire-removal member 5 to be smoothly rotated, and the bolt 7 does not separated from the locking hole 4. The lower end of the sleeve 6 is in flush with the underside of the ring washer 8 can avoid direct contact between the sleeve 6 and the second protrusion 15 so as to ensure that smooth rotation of the tire-removal member 5. The wave washer 9 can avoid the direction contact between the tire-removal member 5 and the body 11 so that the tire-removal member 5 is smoothly rotated.

The present invention provides a chain breaker assembly that is assembled to the folding tool unit 10, wherein the tire-removal member 5 is smoothly pivoted to a perpendicular position relative to the body 11, so that the user can hold the tire-removal member 5 to operate the chain breaker assembly conveniently. There is a sleeve 6 provided to provide a smooth rotation of the tire-removal member 5, so that the tire-removal member 5 does not quickly loosened from the body 11.

While we have shown and described the embodiment in accordance with the present invention, it should be clear to those skilled in the art that further embodiments may be made without departing from the scope of the present invention.

What is claimed is:

1. A bicycle breaker assembly received in a folding tool unit, comprising:
a chain breaker having a body and a push member, the body having a recess defined in a first side of a middle portion of the body, a first protrusion and a second protrusion respectively extending from the first side of two ends of the body, the first protrusion having a threaded hole defined therethrough, the second protrusion having a groove defined in a distal end thereof, the groove communicating with the recess, a locking hole defined in one side of the second protrusion, the push member having a first end adapted to be pivotably connected to the folding tool unit, a second end of the push member threadedly extending through the threaded hole and reaching into the recess, and
a tire-removal member having a first end pivotably connected to the second protrusion, a through hole defined through the first end of the tire-removal member, a sleeve extending through the through hole, a bolt extending through a passage defined axially through the sleeve and being threadedly connected to the locking hole to pivotably connect the first end of the tire-removal member to the body, a stop extending from one side of the tire-removal member at an angle and being removably in contact with a second side of the body to restrict an rotational angle of the tire-removal member relative to the body.

2. The assembly as claimed in claim 1, wherein the second protrusion has a sink hole co-axially defined in one end of the locking hole and communicating with the locking hole, a ring washer is located in the sink hole and has a hole defined therethrough, the sleeve extends through the hole of the ring washer, a lower end of the sleeve is in flush with an underside of the ring washer.

3. The assembly as claimed in claim 2, wherein a wave washer is located in the sink hole, the ring washer is overlapped on the wave washer, the wave washer has multiple peaks and multiple valleys which are located alternatively to the peaks, the peaks contact an inner face of the sink hole and the ring washer to increase a gap between the body and the tire-removal member.

4. The assembly as claimed in claim 1, wherein the body has a first end face formed on an outer side of the second protrusion, and a second end face formed on an outer side of the first protrusion, a resting face is connected between the first and second end faces, the stop of the tire-removal member contacts the first end face when the tire-removal member is pivoted at an angle relative to the body, the second end of the push member reaches into the recess.

5. The assembly as claimed in claim 1, wherein a support member extends from an inner face of the recess and has a curved recess, the support member is located at a distance from the first and second protrusions.

6. The assembly as claimed in claim 1, wherein the tire-removal member has an operation end formed at a second end thereof, the operation end is tapered toward a distal end thereof.
